SEQUENCE LISTING (2 sequences)

SEQ ID NO: 1 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Bacillus lentus
AQSVPWGIRRVQAPTAHNRGLTGSGVKVAVLDTGISTHPDLNIRGGASFVPGEPSTQDENGHGTHAAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGPGLDIVAPGVNIQSTYPGSTYASLNGTSMATPHVAGAAALVKQKNPSWSNVRIRNHLKNTATSLGSTDLYGSGLVNAEAATR

(19) United States
(12) Patent Application Publication
(10) Pub. No.: US 2025/0354091 A1
(43) Pub. Date: Nov. 20, 2025

(54) DETERGENT COMPOSITIONS COMPRISING A PROTEASE ENZYME COATED WITH A DELAYED RELEASE COATING

(71) Applicant: RECKITT BENCKISER FINISH B.V., Hoofddorp (NL)

(72) Inventors: Alias Younis Al-Bayati, Heidelberg (DE); Adrian BARTHOLOMÄ, Heidelberg (DE); Kamila GOLEBIEWSKA, Heidelberg (DE); Marco HAAG, Heidelberg (DE); Ralf HOFSÄSS, Heidelberg (DE); Jörg Peter PFLUG; Torsten ROTH, Heidelberg (DE); Claudia SCHMAELZLE, Heidelberg (DE); Sara TONELLO, Heidelberg (DE); Alexander WINK, Heidelberg (DE)

(21) Appl. No.: 18/876,260

(22) PCT Filed: Jul. 6, 2023
(86) PCT No.: PCT/EP2023/068680

§ 371 Date: Dec. 18, 2024

(30) Foreign Application Priority Data
Jul. 14, 2022 (GB) 2210371.7

(51) Int. Cl. C11D 3/386; C11D 3/20

(52) U.S. Cl. CPC C11D 3/38672; C11D 3/2093

(57) ABSTRACT

The invention is related to a detergent composition comprising at least one protease enzyme having at least 95% identity with SEQ ID NO:1, wherein the or each protease enzyme is coated with a delayed release coating composition comprising at least one hydrophobic species.

### TECHNICAL FIELD OF THE INVENTION

The present invention relates to detergent compositions comprising protease enzymes that are coated with delayed release coating compositions.

### BACKGROUND TO THE INVENTION

Bleaching agents and enzymes have been used for many years as essential actives in dishwashing detergent compositions. However, their activity and performance in such compositions have often been hampered by these two compound classes interfering with each other in their respective modes of action during a dishwashing cycle.

In recent years various strategies have been trialed in an attempt to address this issue. Most strategies have focused on achieving separation of bleaching agents and enzymes during a dishwashing cycle. Such techniques have included programming dishwashing machines to separately deliver the two actives at pre-determined and different timepoints of the dishwashing cycle (“sequential dosing”) and modifying detergents to provide delayed release of one active versus the other (“delayed dosing”).

“Delayed dosing” methods have been promising, as they only rely on the detergent composition and not on the type of dishwashing machine used. However, there is a need for improved detergents which allow for minimal interference between these two actives, and which provide for optimal dishwashing performance.

Delayed dosing of enzymes, such as proteases, amylases, and lipases, can be particularly difficult, as there is a need to ensure distribution of the enzyme at the correct time in the wash cycle, whilst ensuring the enzyme is not denatured or deactivated by other ingredients in the compositions, the coating itself, or the wash conditions. In some cases, a delayed release composition which works with a particular enzyme, such as a specific protease, does not have the same efficacy if the enzyme is changed even for a minor variant of the same enzyme, due to differences in the physical structure and characteristics of the variant compared to its parent.

It is an aim of embodiments of the present invention to address one or more of the problems of the prior art by providing a detergent composition, which offers one or more of the following advantages:
Allows for minimal to no interference between enzymes and other actives, particularly bleaching agents, throughout a dishwashing cycle.
Excellent performance, especially in automatic dishwashing applications.
Excellent consumer-relevant performance benefits.
Good handling.
Low-cost production.
Simple manufacture.

It is also an aim of embodiments of the present invention to overcome or mitigate at least one problem of the prior art, whether expressly disclosed herein or not.

### SUMMARY OF THE INVENTION

According to a first aspect of the invention, there is provided a detergent composition comprising at least one protease enzyme having at least 95% identity with SEQ ID NO: 1, wherein the or each protease enzyme is coated with a delayed release coating composition comprising at least one hydrophobic species.

SEQ ID NO:1 corresponds to the amino acid sequence of subtilisin 309 from Bacillus lentus.

In some embodiments the protease comprises at least 95.5%, 96%, 96.5% or at least 97% identity with SEQ ID NO:1.

In preferred embodiments the protease comprises a variant of the amino acid sequence of SEQ ID NO: 1 comprising a substitution at one or more positions selected from 9, 15, 59, 66, 188, 199, 239 and 255. In some embodiments the protease variant comprises at least two, three, four, five, six, seven or all eight substitutions at positions 9, 15, 59, 66, 188, 199, 239 and 255.

When a substitution occurs at position 9, it is preferably S9R.

When a substitution occurs at position 15, it is preferably A15T.

When a substitution occurs at position 59, it is preferably G59E.

When a substitution occurs at position 66, it is preferably V66A.

When a substitution occurs at position 188, it is preferably A188P.

When a substitution occurs at position 199, it is preferably V199I.

When a substitution occurs at position 239, it is preferably Q239R.

When a substitution occurs at position 255, it is preferably N255D.

Thus, in a preferred embodiment, the detergent composition comprises a variant of SEQ ID NO: 1 comprising substitutions at positions 9, 15, 59, 66, 188, 199, 239 and 255, more preferably comprising the substitutions S9R, A15T, G59E, V66A, A188P, V199I, Q239R and N255D.

According to a second aspect of the invention there is provided a detergent composition comprising a protease enzyme having at least 99% identity with SEQ ID NO:2, preferably having 100% identity with SEQ ID NO:2, wherein the or each protease enzyme is coated with a delayed release coating composition comprising at least one hydrophobic species.

In some embodiments of the second aspect of the invention the protease consists of the amino acid sequence of SEQ ID NO:2. In some embodiments the protease is a variant of Bacillus lentus subtilisin 309 subtilase, comprising the substitutions S9R, A15T, G59E, V66A, A188P, V199I, Q239R and N255D.

In some embodiments, at least one hydrophobic species comprises at least one fatty acid and/or ester thereof.

The fatty acid and/or ester thereof may be present in a total combined amount of at least 0.25 wt % of the delayed release coating composition, or at least 0.5, 0.75, 1, 2, 3, 4, or at least 5, 6, 7, 8, 9, 10, 15, 20, 25, or at least 30 wt %, or at least 31 wt % of the delayed release coating composition. In some embodiments, the fatty acid and/or ester thereof may be present in a total combined amount of greater than 31 wt % of the delayed release coating composition, or in a total combined amount of at least 32 wt %, or at least 33, 34, or at least 35, 40, 45, 50, 55, 60, 65, 70, 75, 80, 85, 90, or at least 95 wt % of the delayed release coating composition.

The fatty acid and/or ester thereof may be present in a total combined amount of no greater than 95 wt % of the delayed release coating composition, or no greater than 90, 85, 80, 75, 70, 65, 60, 55, 50, 45, 40, or no greater than 35 wt % of the delayed release coating composition.

The fatty acid and/or ester thereof may be present in a total combined amount of between 1-95 wt % of the delayed release coating composition, or between 5-90, 10-80, or between 20-70 wt %, or between 25-60 wt % of the delayed release coating composition. The fatty acid and/or ester thereof may be present in a total combined amount of between 5-55 wt % of the delayed release coating composition, or between 10-50, 15-45, 20-40, or between 25-35 wt % of the delayed release coating composition. In some embodiments, the fatty acid and/or ester thereof may be present in a total combined amount of between 31-95 wt % of the delayed release coating composition, or between 35-95 wt % of the delayed release coating composition.

At least 40 wt % of the total combined amount of fatty acid and ester thereof may be present as a fatty acid ester, or at least 50, 60, 70, 80, 90, or at least 95 wt % of the total combined amount of fatty acid and ester thereof may be present as a fatty acid ester. Substantially 100 wt % of the total combined amount of fatty acid and ester thereof may be present as a fatty acid ester.

At least one fatty acid or ester thereof may preferably comprise a linear fatty acid chain. At least one fatty acid or ester thereof may have a fatty acid chain length of at least 4 carbon atoms, or at least 6, 8, preferably at least 10, 12, preferably at least 14, 16, or at least 18 carbon atoms. At least one fatty acid or ester thereof may have a fatty acid chain length of no greater than 40 carbon atoms, or no greater than 38, 36, 34, 32, 30, 28, 26, 24, 22, 20, or no greater than 18 carbon atoms. At least one fatty acid or ester thereof may have a fatty acid chain length of between 4-40 carbon atoms, or between 4-30, 6-28, 6-26, 6-24, 8-24, 8-22, or between 10-20, or between 12-20, preferably between 14-20, or between 14-18, or between 14-16, or between 16-18 carbon atoms.

At least one fatty acid or ester thereof may comprise an even- and/or odd-chained fatty acid, preferably an even-chained fatty acid.

At least one fatty acid or ester thereof may have a saturated and/or unsaturated fatty acid chain, preferably a saturated fatty acid chain. At least 50% of the total number of fatty acids and esters thereof in the delayed release coating composition may have a saturated fatty acid chain, or at least 60, 70, 80, 90, or at least 95% of the total number of fatty acids and esters thereof in the delayed release coating composition may have a saturated fatty acid chain. In some embodiments, substantially 100% of the total number of fatty acids and esters thereof in the delayed release coating composition have a saturated fatty acid chain.

In some embodiments, at least one fatty acid or ester thereof comprises at least one saturated fatty acid or ester thereof, wherein the fatty acid is independently selected from the group comprising: caprylic acid, capric acid, lauric acid, myristic acid, palmitic acid, stearic acid, arachidic acid, behenic acid, lignoceric acid, cerotic acid, and combinations thereof. At least one fatty acid or ester thereof may preferably comprise at least one saturated fatty acid or ester thereof, wherein the fatty acid is independently selected from the group comprising: myristic acid, palmitic acid, stearic acid, and combinations thereof. In preferred embodiments, the hydrophobic species comprises stearic acid and/or an ester thereof.

At least one fatty acid or ester thereof may have an unsaturated fatty acid chain. At least one fatty acid or ester thereof may have an unsaturated fatty acid chain comprising at least one cis and/or at least one trans double bond. In some embodiments, at least one fatty acid or ester thereof comprises at least one unsaturated fatty acid or ester thereof, wherein the fatty acid is independently selected from the group comprising: myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, and combinations thereof. At least one fatty acid or ester thereof may preferably comprise at least one unsaturated fatty acid or ester thereof, wherein the fatty acid is independently selected from the group comprising: oleic acid, linoleic acid, and combinations thereof.

In some embodiments, the hydrophobic species comprises at least one saturated fatty acid or ester thereof and at least one unsaturated fatty acid or ester thereof. The saturated fatty acid or ester thereof and the unsaturated fatty acid or ester thereof may be present in a saturated fatty acid or ester to unsaturated fatty acid or ester weight ratio of between 1:5 to 5:1, or between 1:4 to 4:1, or between 1:3 to 3:1, or between 1:2 to 2:1, or of around 1:1.

In some embodiments, at least one fatty acid or ester thereof may comprise a fatty acid that is independently selected from the group comprising: myristic acid, palmitic acid, stearic acid, oleic acid, linoleic acid, and combinations thereof. In some embodiments, at least one fatty acid or ester thereof comprises a fatty acid that is independently selected from the group comprising: myristic acid, palmitic acid, stearic acid, and combinations thereof.

In preferred embodiments, at least one hydrophobic species comprises at least one fatty acid ester. In some embodiments, at least one hydrophobic species comprises at least one glycerol and/or sorbitan fatty acid ester.

At least one glycerol fatty acid ester may be independently selected from the group comprising: a monoglyceride, a diglyceride, a triglyceride, and combinations thereof. The fatty acid of at least one glycerol fatty acid ester may preferably be as described in statements of invention above. In some embodiments, at least one hydrophobic species comprises at least one monoglyceride. At least one monoglyceride may be a saturated monoglyceride. At least one monoglyceride may have a fatty acid chain length of between 14-20 carbon atoms, or between 14-18, or between 16-18 carbon atoms. At least one monoglyceride may preferably be glycerol monostearate.

At least one sorbitan fatty acid ester may be independently selected from the group comprising: a sorbitan monoester, a sorbitan diester, a sorbitan triester, and combinations thereof. The fatty acid of at least one sorbitan fatty acid ester may preferably be as described in statements of invention above. In some embodiments, at least one hydrophobic species comprises at least one fatty acid sorbitan monoester. At least one fatty acid sorbitan monoester may be a saturated monoester. At least one fatty acid sorbitan monoester may have a fatty acid chain length of between 14-20 carbon atoms, or between 14-18, or between 16-18 carbon atoms. At least one sorbitan monoester may preferably be sorbitan monostearate.

In some embodiments, at least one fatty acid or ester thereof is derived from a fat or an oil. In some embodiments, the delayed release coating composition comprises at least one fat and/or oil. The delayed release coating composition may comprise at least one hydrogenated fat and/or oil. The delayed release coating composition may comprise at least one vegetable oil. The delayed release coating composition may comprise at least one fat or oil that is independently selected from the group comprising: coconut oil, cocoa butter, palm kernel oil, palm oil, cottonseed oil, wheat germ oil, soybean oil, olive oil, corn oil, sunflower oil, safflower oil, hemp oil, rapeseed oil, and combinations thereof. The delayed release coating composition may preferably comprise palm oil, preferably hydrogenated palm oil.

The delayed release coating composition may comprise palm oil, preferably hydrogenated palm oil in a total amount of at least 0.25 wt % of the delayed release coating composition, or at least 0.5, 0.75, 1, 2, 3, 4, or at least 5, 6, 7, 8, 9, 10, 15, 20, 25, or at least 30 wt %, or at least 31 wt % of the delayed release coating composition. In some embodiments, the delayed release coating composition may comprise palm oil, preferably hydrogenated palm oil in a total amount of greater than 31 wt % of the delayed release coating composition, or in a total amount of at least 32 wt %, or at least 33, 34, or at least 35, 40, 45, 50, 55, 60, 65, 70, 75, 80, 85, 90, or at least 95 wt % of the delayed release coating composition.

The delayed release coating composition may comprise palm oil, preferably hydrogenated palm oil in a total amount of no greater than 95 wt % of the delayed release coating composition, or no greater than 90, 85, 80, 75, 70, 65, 60, 55, 50, 45, 40, or of no greater than 35 wt % of the delayed release coating composition.

The delayed release coating composition may comprise palm oil, preferably hydrogenated palm oil in a total amount of between 1-95 wt % of the delayed release coating composition, or between 5-90, 10-80, or between 20-70 wt %, or between 25-60 wt % of the delayed release coating composition. The delayed release coating composition may comprise palm oil, preferably hydrogenated palm oil in a total amount of between 5-55 wt % of the delayed release coating composition, or between 10-50, 15-45, 20-40, or between 25-35 wt % of the delayed release coating composition. In some embodiments, the delayed release coating composition may comprise palm oil, preferably hydrogenated palm oil in a total amount of between 31-95 wt % of the delayed release coating composition, or between 35-95 wt % of the delayed release coating composition.

In some embodiments, at least one hydrophobic species comprises at least one hydrocarbon.

The hydrocarbon may be present in a total amount of at least 0.25 wt % of the delayed release coating composition, or at least 0.5, 0.75, 1, 2, 3, 4, or at least 5, 6, 7, 8, or at least 9, 10, 15, 20, 25, or at least 30 wt %, or at least 31 wt % of the delayed release coating composition. In some embodiments, the hydrocarbon may be present in a total amount of greater than 31 wt % of the delayed release coating composition, or in a total amount of at least 32 wt %, or at least 33, 34, or at least 35, 40, 45, 50, 55, 60, 65, 70, 75, 80, 85, 90, or at least 95 wt % of the delayed release coating composition.

The hydrocarbon may be present in a total amount of no greater than 95 wt % of the delayed release coating composition, or no greater than 90, 85, 80, 75, 70, 65, 60, 55, 50, 45, 40, or no greater than 35 wt % of the delayed release coating composition.

The hydrocarbon may be present in a total amount of between 1-95 wt % of the delayed release coating composition, or between 5-90, 10-80, or between 20-70 wt %, or between 25-60 wt % of the delayed release coating composition. The hydrocarbon may be present in a total amount of between 5-55 wt % of the delayed release coating composition, or between 10-50, 15-45, 20-40, or between 25-35 wt % of the delayed release coating composition. In some embodiments, the hydrocarbon may be present in a total amount of between 31-95 wt % of the delayed release coating composition, or between 35-95 wt % of the delayed release coating composition.

At least one hydrocarbon may be an aliphatic and/or aromatic hydrocarbon, preferably an aliphatic hydrocarbon. At least one hydrocarbon may be saturated and/or unsaturated. At least one hydrocarbon may be independently selected from the group comprising: a linear hydrocarbon, a branched hydrocarbon, and a cyclic hydrocarbon.

In preferred embodiments, at least one hydrocarbon is a saturated aliphatic hydrocarbon. At least one hydrocarbon may preferably be an alkane.

At least one hydrocarbon, preferably at least one saturated aliphatic hydrocarbon, may have at least 4 carbon atoms, or at least 6, 8, 10, 12, 14, or at least 16, 18, or at least 20 carbon atoms. At least one hydrocarbon, preferably at least one saturated aliphatic hydrocarbon, may have no greater than 60 carbon atoms, or no greater than 58, 56, 54, 52, 50, 48, 46, 44, 42, or no greater than 40 carbon atoms. At least one hydrocarbon, preferably at least one saturated aliphatic hydrocarbon, may have between 5-60 carbon atoms, or between 10-50 carbon atoms, or between 15-45 carbon atoms, or between 20-40 carbon atoms. In such embodiments, the hydrocarbon may be a linear hydrocarbon and may comprise a single carbon chain.

At least one hydrocarbon may be a paraffin derivative. In some embodiments, the delayed release coating composition comprises paraffin. The delayed release coating composition may comprise at least one paraffin that is independently selected from the group comprising: low melting point paraffin, mid melting point paraffin, high melting point paraffin, and combinations thereof. The delayed release coating composition may comprise at least one paraffin having a melting point of at least 25° C., or at least 30, 35, 40, 45, or preferably at least 50° C., or at least 55, or at least 60° C. The delayed release coating composition may comprise at least one paraffin having a melting point of no greater than 100° C., or no greater than 95, 90, 85, 80, 75, 70, 65, or no greater than 60° C. The delayed release coating composition may comprise at least one paraffin having a melting point of between 25-85° C., or between 30-80, 35-75, 40-70, 45-65, or preferably between 50-60° C. The delayed release coating composition may comprise at least one paraffin having a melting point of between 25-95° C., or between 30-90, 35-85, 40-80, 45-75, 50-70, or preferably between 55-65° C. The delayed release coating composition may comprise at least one paraffin having a melting point of between 40-100° C., or between 45-95, 50-90, 55-85, 60-80, or preferably between 65-75° C.

The delayed release coating composition may comprise paraffin in a total amount of at least 0.25 wt % of the delayed release coating composition, or at least 0.5, 0.75, 1, 2, 3, 4, or at least 5, 6, 7, 8, 9, 10, 15, 20, 25, or at least 30 wt %, or at least 31 wt % of the delayed release coating composition. In some embodiments, the delayed release coating composition may comprise paraffin in a total amount of greater than 31 wt % of the delayed release coating composition, or in a total amount of at least 32 wt %, or at least 33, 34, or at least 35, 40, 45, 50, 55, 60, 65, 70, 75, 80, 85, 90, or at least 95 wt % of the delayed release coating composition.

The delayed release coating composition may comprise paraffin in a total amount of no greater than 95 wt % of the delayed release coating composition, or no greater than 90, 85, 80, 75, 70, 65, 60, 55, 50, 45, 40, or of no greater than 35 wt % of the delayed release coating composition.

The delayed release coating composition may comprise paraffin in a total amount of between 1-95 wt % of the delayed release coating composition, or between 5-90, 10-80, or between 20-70 wt %, or between 25-60 wt % of the delayed release coating composition. The delayed release coating composition may comprise paraffin in a total amount of between 5-55 wt % of the delayed release coating composition, or between 10-50, 15-45, 20-40, or between 25-35 wt % of the delayed release coating composition. In some embodiments, the delayed release coating composition may comprise paraffin in a total amount of between 31-95 wt % of the delayed release coating composition, or between 35-95 wt % of the delayed release coating composition.

At least 5 wt % of the total amount of paraffin in the delayed release coating composition may have a melting point of between 50-60° C., or at least 10 wt %, 15, 20, 25, 30, 35, 40, 45, 50, 55, 60, 65, 70, 75, 80, 85, 90, 95, 96, 97, 98, or at least 99 wt % of the total amount of paraffin in the delayed release coating composition may have a melting point of between 50-60° C. In some embodiments, no greater than 95 wt % of the total amount of paraffin in the delayed release coating composition has a melting point of between 50-60° C., or no greater than 90, 85, 80, 75, 70, 65, or no greater than 60 wt % of the total amount of paraffin in the delayed release coating composition has a melting point of between 50-60° C.

At least 5 wt % of the total amount of paraffin in the delayed release coating composition may have a melting point of between 55-65° C., or at least 10 wt %, 15, 20, 25, 30, 35, 40, 45, 50, 55, 60, 65, 70, 75, 80, 85, 90, 95, 96, 97, 98, or at least 99 wt % of the total amount of paraffin in the delayed release coating composition may have a melting point of between 55-65° C. In some embodiments, no greater than 95 wt % of the total amount of paraffin in the delayed release coating composition has a melting point of between 55-65° C., or no greater than 90, 85, 80, 75, 70, 65, or no greater than 60 wt % of the total amount of paraffin in the delayed release coating composition has a melting point of between 55-65° C.

At least 5 wt % of the total amount of paraffin in the delayed release coating composition may have a melting point of between 65-75° C., or at least 10 wt %, 15, 20, 25, 30, 35, 40, 45, 50, 55, 60, 65, 70, 75, 80, 85, 90, 95, 96, 97, 98, or at least 99 wt % of the total amount of paraffin in the delayed release coating composition may have a melting point of between 65-75° C. In some embodiments, no greater than 95 wt % of the total amount of paraffin in the delayed release coating composition has a melting point of between 65-75° C., or no greater than 90, 85, 80, 75, 70, 65, or no greater than 60 wt % of the total amount of paraffin in the delayed release coating composition has a melting point of between 65-75° C.

In some embodiments, at least one hydrophobic species may be independently selected from the group comprising: a palm oil derivative, a sorbitan ester, a glycerol ester, a paraffin derivative, and combinations thereof. In such embodiments, the palm oil derivative preferably comprises at least one fatty acid or ester thereof, preferably as described in statements of invention above. The palm oil derivative may comprise at least one linear fatty acid or ester thereof, preferably having a chain length of between 14-20 carbon atoms. In such embodiments, the sorbitan ester may comprise a sorbitan fatty acid ester, preferably as described in statements of invention above. The sorbitan ester may comprise at least one sorbitan fatty acid monoester, preferably a monoester of a saturated fatty acid, which preferably has a fatty acid chain length of between 14-20 carbon atoms. In such embodiments, the glycerol ester may comprise at least one fatty acid glyceride, which may be a monoglyceride, and which may have a fatty acid chain length of between 14-20 carbon atoms. In such embodiments, the paraffin derivative may preferably comprise at least one hydrocarbon, preferably as described in statements of invention above. The paraffin derivative may comprise at least one saturated aliphatic hydrocarbon, which may have between 20-40 carbon atoms.

In some preferred embodiments, at least one hydrophobic species may be independently selected from the group comprising: a palm oil derivative, a sorbitan ester, and combinations thereof.

At least one hydrophobic species may be independently selected from the group comprising: a fatty acid or ester thereof derived from palm oil, a sorbitan ester, and combinations thereof. At least one hydrophobic species may be independently selected from the group comprising: a linear fatty acid or ester thereof having a fatty acid chain length of between 14-20 carbon atoms derived from palm oil, a sorbitan ester, and combinations thereof.

At least one hydrophobic species may be independently selected from the group comprising: a palm oil derivative, a sorbitan fatty acid ester, and combinations thereof. At least one hydrophobic species may be independently selected from the group comprising: a palm oil derivative, a sorbitan fatty acid monoester, and combinations thereof. At least one hydrophobic species may be independently selected from the group comprising: a palm oil derivative, a sorbitan saturated fatty acid monoester having a fatty acid chain length of between 14-20 carbon atoms, and combinations thereof. At least one hydrophobic species may preferably be independently selected from the group comprising: a palm oil derivative, sorbitan monostearate, and combinations thereof.

At least one hydrophobic species may be independently selected from the group comprising: a fatty acid or ester thereof derived from palm oil, a sorbitan fatty acid monoester, and combinations thereof. At least one hydrophobic species may be independently selected from the group comprising: a linear fatty acid or ester thereof having a fatty acid chain length of between 14-20 carbon atoms derived from palm oil, a sorbitan saturated fatty acid monoester having a fatty acid chain length of between 14-20 carbon atoms, and combinations thereof. At least one hydrophobic species may be independently selected from the group comprising: a linear fatty acid or ester thereof having a fatty acid chain length of between 14-20 carbon atoms derived from palm oil, sorbitan monostearate, and combinations thereof.

In some embodiments, at least one hydrophobic species may be or be derived from at least one hydrophobic substance that is independently selected from the group comprising: a wax, a fat, an oil, a resin, and combinations thereof. The delayed release coating composition may comprise a hydrophobic substance that is independently selected from the group comprising: tripalmitin, palm oil, jojoba oil, carnauba wax, polyesters, polyester block copolymers such as polyethylene terephthalate/polyoxyethylene terephthalate (PET/POET) block copolymers, polycaprolactone, and combinations thereof.

The hydrophobic species may be present in a total amount of at least 0.25 wt % of the delayed release coating composition, or at least 0.5, 0.75, 1, 2, 3, 4, or at least 5, 6, 7, 8, 9, 10, 15, 20, 25, or at least 30 wt %, or at least 31 wt % of the delayed release coating composition. In some embodiments, hydrophobic species may be present in a total amount of greater than 31 wt % of the delayed release coating composition, or in a total amount of at least 32 wt %, or at least 33, 34, or at least 35, 40, 45, 50, 55, 60, 65, 70, 75, 80, 85, 90, or at least 95 wt % of the delayed release coating composition.

The hydrophobic species may be present in a total amount of no greater than 95 wt % of the delayed release coating composition, or no greater than 90, 85, 80, 75, 70, 65, 60, 55, 50, 45, 40, or of no greater than 35 wt % of the delayed release coating composition.

The hydrophobic species may be present in a total amount of between 1-95 wt % of the delayed release coating composition, or between 5-90, 10-80, or between 20-70 wt %, or between 25-60 wt % of the delayed release coating composition. The hydrophobic species may be present in a total amount of between 5-55 wt % of the delayed release coating composition, or between 10-50, 15-45, 20-40, or between 25-35 wt % of the delayed release coating composition. In some embodiments, the hydrophobic species may be present in a total amount of between 31-95 wt % of the delayed release coating composition, or between 35-95 wt % of the delayed release coating composition.

At least one hydrophobic species may have a melting point of at least 20° C., or at least 25, 30, 35, or at least 40° C. At least one hydrophobic species may have a melting point of no greater than 150° C., or no greater than 140, 130, 120, 110, or no greater than 100° C. At least one hydrophobic species may have a melting point of between 30-100° C., or between 40-60° C.

The delayed release coating composition may further comprise at least one water-insoluble substance. At least one water-insoluble substance may preferably comprise a clay mineral. At least one water-insoluble substance may be independently selected from the group comprising: kaolin, talc, titanium dioxide, calcium carbonate, and combinations thereof. In preferred embodiments, at least one water-insoluble substance is kaolin.

The water-insoluble substance may be present in a total amount of at least 2 wt % of the delayed release coating composition, or at least 4, 6, 8, 10, 12, 14, 16, 18, or at least 20, 25, 30, 35, 40, 45, 50, 55, 60, or at least 65 wt % of the delayed release coating composition. The water-insoluble substance may be present in a total amount of no greater than 90 wt % of the delayed release coating composition, or no greater than 85, 80, 75, 70, 65, 60, 55, 50, 45, 40, 35, 30, 25, 20, 15, 10, or no greater than 5 wt % of the delayed release coating composition. The water-insoluble substance may be present in a total amount of between 5-90 wt % of the delayed release coating composition, or between 10-85, 20-80, 30-75, or between 40-70 wt % of the delayed release coating composition. The water-insoluble substance may be present in a total amount of between 5-80, 5-70, 5-60, 5-50, 5-40, 5-30, 5-20, or between 5-10 wt % of the delayed release coating composition.

The water-insoluble substance may be present in a total amount of between 40-95 wt % of the delayed release coating composition, or between 45-90, 50-85, 55-80, or between 60-75 wt % of the delayed release coating composition.

In some embodiments, the delayed release coating composition comprises at least one salt. At least one salt may be an inorganic salt. At least one salt may be independently selected from the group comprising: a sulfate, sulfite, phosphate, phosphonate, nitrate, chloride, carbonate, and combinations thereof. At least one salt may be a salt of an organic acid, such as a citrate, malonate, and/or acetate. At least one salt may comprise a cation that is independently selected from the group comprising: an alkali metal cation, an alkaline earth metal cation, an ammonium cation, and combinations thereof. At least one cation may be independently selected from the group comprising: sodium, potassium, magnesium, calcium, zinc, aluminium, and combinations thereof. At least one salt may comprise an anion that is independently selected from the group comprising: chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, lactate, formate, acetate, butyrate, propionate, benzoate, tartrate, ascorbate, gluconate, and combinations thereof. At least one salt may comprise an alkali metal or alkaline earth metal salt of a counterion that is independently selected from the group comprising: sulfate, sulfite, phosphate, phosphonate, nitrate, chloride, carbonate, citrate, malonate, acetate, and combinations thereof. At least one salt may be a hydrated salt comprising water of crystallisation.

At least one salt may preferably comprise a sulfate. At least one salt may comprise an alkali metal sulfate, preferably sodium sulfate.

The salt may be present in the delayed release coating composition in a total amount of at least 5 wt % of the delayed release coating composition, or at least 10, 15, 20, 25, 30, 35, 40, or at least 45 wt % of the delayed release coating composition. The salt may be present in the delayed release coating composition in a total amount of no greater than 90 wt % of the delayed release coating composition, or no greater than 85, 80, 75, 70, or no greater than 65 wt % of the delayed release coating composition. The salt may be present in the delayed release coating composition in a total amount of between 20-90 wt % of the delayed release coating composition, or between 25-85, 30-80, 35-75, 40-70, or between 45-65 wt % of the delayed release coating composition.

In some embodiments, the delayed release coating composition comprises at least one polysaccharide. At least one polysaccharide may be an unmodified naturally occurring polysaccharide or a modified naturally occurring polysaccharide. At least one polysaccharide may be independently selected from the group comprising: cellulose, pectin, dextrin, starch, and combinations thereof. The starch may be water-soluble or water-insoluble. At least one polysaccharide may preferably be dextrin.

The polysaccharide may be present in the delayed release coating composition in a total amount of at least 0.25 wt % of the delayed release coating composition, or at least 0.5, 0.75, 1, 1.1, 1.2, or at least 1.3, 1.4, 1.5, 1.6, 1.7, 1.8, 1.9, or at least 2 wt % of the delayed release coating composition. The polysaccharide may be present in the delayed release coating composition in a total amount of no greater that 15 wt % of the delayed release coating composition, or no greater than 14, 13, 12, 11, 10, 9, 8, 7, 6, or no greater than 5 wt % of the delayed release coating composition. The polysaccharide may be present in the delayed release coating composition in a total amount of between 0.25-10 wt % of the delayed release coating composition, or between 0.5-8, or between 1-6 wt % of the delayed release coating composition.

In some embodiments, the delayed release coating composition further comprises at least one surfactant. At least one surfactant may be a non-ionic surfactant. At least one surfactant may be a polyether. At least one surfactant may be a polyalkylene glycol, which may be independently selected from the group comprising: polyethylene glycol, polypropylene glycol, and combinations thereof. At least one surfactant may be a polyethylene glycol.

The delayed release coating composition may comprise at least one polyalkylene glycol, preferably at least one polyethylene glycol, with an average molecular weight of at least 500 Da, or at least 1000, 1500, 2000, 2500, 3000, or at least 3500 Da. The delayed release coating composition may comprise at least one polyalkylene glycol, preferably at least one polyethylene glycol, with an average molecular weight of no greater than 10,000 Da, or no greater than 9000, 8000, 7000, 6000, or no greater than 5000 Da.

The delayed release coating composition may comprise at least one polyalkylene glycol, preferably at least one polyethylene glycol, with an average molecular weight of between 500-8000 Da, or between 1000-7000, 2000-6000, 3000-5000, or between 3500-4500 Da.

In some embodiments, the delayed release coating composition is present in a total amount of at least 0.05 wt % of the detergent composition, or at least 0.1, 0.15, 0.2, or at least 0.25 wt % of the detergent composition, or at least 0.3, 0.35, 0.4, 0.45, 0.5, 0.55, 0.6, 0.65, 0.7, or at least wt % of the detergent composition. The delayed release coating composition may be present in a total amount of no greater than 10 wt % of the detergent composition, or no greater than 9, 8, 7, 6, 5, 4, or no greater than 3, or no greater than 2.5, 2, 1.5, 1, 0.9, or no greater than 0.8 wt % of the detergent composition. The delayed release coating composition may be present in a total amount of between 0.05-7 wt % of the detergent composition, or between 0.1-5, 0.1-4, 0.1-3, 0.1-2, 0.1-1.5, 0.25-1.25, or between 0.5-1 wt % of the detergent composition.

In some embodiments, the protease enzyme is present in a total amount of at least 0.0025 wt % of the detergent composition, or at least 0.005, 0.0075, 0.01, 0.025, 0.05, 0.075, or at least 0.1, 0.2, 0.3, 0.4, or at least 0.5 wt % of the detergent composition. The protease enzyme may be present in a total amount of no greater than 10 wt % of the detergent composition, or no greater than 5, 4, 3, 2, or no greater than 1 wt % of the detergent composition. The protease enzyme may be present in a total amount of between 0.2-10 wt % of the detergent composition, or between 0.3-5, or between 0.4-4 wt % of the detergent composition.

At least one protease enzyme may be present in granular or particulate form.

In some embodiments wherein the at least one protease enzyme is present in granular form, the active enzyme protein within such a granule ranges from 0.02 to 2.5 wt %.

In some embodiments, the detergent composition comprises at least one particle comprising a core comprising the protease enzyme, wherein the core is coated with the delayed release coating composition.

The particles may be present in the detergent composition in a total amount of at least 0.25 wt %, or at least 0.5, 0.75, 1, 1.25, 1.5, 1.75, 2, 2.25, or at least 2.5 wt % of the detergent composition. The particles may be present in the detergent composition in a total amount of no greater than 15 wt % of the detergent composition, or no greater than 14, 13, 12, 11, 10, 9, 8, 7, 6, 5, 4, or no greater than 3 wt % of the detergent composition. The particles may be present in the detergent composition in a total amount of between 0.25-7 wt % of the detergent composition, or between 0.5-6, 1-5, or between 2-5 wt % of the detergent composition.

In some embodiments, at least one particle comprises the delayed release coating composition in a total amount of at least 1 wt % of the particle, or at least 2, 3, 4, 5, 10, 15, 20, or at least 25 wt % of the particle. At least one particle may comprise the delayed release coating composition in a total amount of no greater than 95 wt % of the particle, or no greater than 90, 85, 80, 75, 70, 65, 60, 55, 50, 45, 40, 35, or no greater than 30 wt % of the particle. At least one particle may comprise the delayed release coating composition in a total amount of between 5-45 wt % of the particle, or between 10-40, 15-35, or between 20-30 wt % of the particle.

The delayed release coating composition may preferably be present as a layer surrounding the core. In some embodiments, the delayed release coating composition layer has a thickness of between 0.5-1500 μm. The delayed release coating composition layer may have a thickness of at least 30 μm, or at least 50, or at least 75 μm. The delayed release coating composition layer may have a thickness of no greater than 1000 μm, or no greater than 500, 250, or no greater than 150 μm.

The delayed release coating composition may be present as a single coating layer surrounding the core. Alternatively, the delayed release coating composition may be present as more than one layer surrounding the core. In some embodiments, the delayed release coating composition comprises 2 or at least 2 layers, or 3 or at least 3 layers surrounding the core.

In some embodiments, the core may also be coated with an undercoat and/or topcoat layer.

The delayed release coating composition may directly contact the protease enzyme, or may indirectly contact the protease enzyme via an undercoat layer. The delayed release coating composition may comprise an outer layer of the particle. Alternatively, the delayed release coating composition may comprise an inner layer of the particle.

At least one particle may comprise an undercoat and/or topcoat layer, preferably an undercoat layer. At least one particle may comprise a single undercoat layer. At least one particle may comprise an undercoat or topcoat layer, preferably an undercoat layer, which is a salt layer. The salt layer may comprise at least one salt, preferably as described in statements of invention above. The salt layer may preferably comprise a sulfate salt, preferably an alkali metal sulfate salt, which may be or comprise sodium sulfate.

The salt may be present in a total amount of at least 30 wt % of the salt layer, or at least 40, 50, 60, 70, 80, 90, 95, 96, 97, 98, or at least 99 wt % of the salt layer. The salt layer may be entirely composed of a salt. The salt may be present in a total amount of no greater than 95 wt % of the salt layer, or no greater than 90, 85, or no greater than 80 wt % of the salt layer. The salt may be present in a total amount of between 40-95 wt % of the salt layer, or between 50-90, 60-85, or between 70-80 wt % of the salt layer.

The salt layer may further comprise at least one component independently selected from the group comprising: a water-insoluble substance, a polysaccharide, and combinations thereof.

The salt layer may further comprise at least one water-insoluble substance, preferably as described in statements of invention above. At least one water-insoluble substance may be kaolin. The salt layer may comprise the water-insoluble substance in a total amount of at least 1 wt % of the salt layer, or at least 2, 3, 4, 5, 6, 7, or at least 8 wt % of the salt layer. The salt layer may comprise the water-insoluble substance in a total amount of no greater than 20 wt % of the salt layer, or no greater than 15, or no greater than 10 wt % of the salt layer. The salt layer may comprise the water-insoluble substance in a total amount of between 1-15 wt % of the salt layer, or between 2-10 wt % of the salt layer.

The salt layer may further comprise at least one polysaccharide, which may be independently selected from the group comprising: cellulose, pectin, dextrin, starch, and combinations thereof. The salt layer may preferably comprise cellulose and dextrin. The salt layer may comprise the polysaccharide in a total amount of at least 1 wt % of the salt layer, or at least 2, 3, 4, 5, 6, 7, 8, 9, or at least 10 wt % of the salt layer. The salt layer may comprise the polysaccharide in a total amount of no greater than 50 wt % of the salt layer, or no greater than 45, 40, 35, 30, 25, 20, or no greater than 15 wt % of the salt layer. The salt layer may comprise the polysaccharide in a total amount of between 1-30 wt % of the salt layer, or between 5-25, or between 10-20 wt % of the salt layer.

In some embodiments, the salt layer has a thickness of between 1-1000 μm, or between 2-100 μm, or between 3-20 μm. The salt layer may have a thickness of less than 500 μm, or less than 250 μm, 80, 50, or less than 30 μm. In some embodiments, the salt layer has a thickness of between 2-5 μm.

In some embodiments, at least one undercoat and/or topcoat layer may comprise a compound that is independently selected from the group comprising: polyethylene glycol, polyvinyl alcohol, hydroxypropyl methyl cellulose, and combinations thereof.

The core of at least one particle may have a diameter of between 20-2000 μm, or between 50-1500 μm, 100-1500 μm, or between 250-1200 μm.

The core of at least one particle preferably comprises the protease enzyme. In some embodiments, at least one particle comprises the protease enzyme in a total amount of at least 5 wt % of the particle, or at least 10, or at least 15 wt % of the particle. At least one particle may comprise the protease enzyme in a total amount of no greater than 60 wt % of the particle, or no greater than 55, 50, 45, 40, 35, 30, or no greater than 25 wt % of the particle. At least one particle may comprise the protease enzyme in a total amount of between 5-45 wt % of the particle, or between 10-40, 15-35, or between 20-30 wt % of the particle. The core of at least one particle may comprise an inert particle with the enzyme absorbed into it, or with the enzyme applied to a surface thereof.

At least one particle may have a protease enzyme release profile such that the time required to release 50% of the enzyme is at least 100 seconds, at least 200 seconds or at least 300 seconds. The time required to release 50% of the enzyme may be at least 1.5 times, at least 2 times or at least 3 times longer than the time required for analogous enzyme-containing particles which are not coated with the delayed release coating composition.

The core of at least one particle may further comprise at least one binder, which may be independently selected from the group comprising: a polymer, wax, fat, carbohydrate, and combinations thereof. The core of at least one particle may further comprise at least one material independently selected from the group comprising: a filler, a fibre material (which may comprise cellulose or synthetic fibres), a stabilising agent, a solubilising agent, a suspension agent, a viscosity regulating agent, a light sphere, a plasticizer, a salt, a lubricant, a fragrance, and combinations thereof.

The core of at least one particle may comprise a polymer, which may be a synthetic polymer. At least one polymer may be independently selected from the group comprising: polyvinyl pyrrolidone, polyvinyl alcohol, polyvinyl acetate, polyacrylate, polymethacrylate, polyacrylamide, polysulfonate, polycarboxylate, and copolymers and/or combinations thereof. At least one polymer may comprise a water-soluble polymer or copolymer. At least one polymer may be a vinyl polymer.

In some embodiments, at least one polymer has a molecular weight of between 1000-1,500,000 Da. At least one polymer may have a molecular weight of no greater than 1,000,000 Da, or no greater than 800,000 Da, or no greater than 200,000 Da, or no greater than 100,000 Da. At least one polymer may have a molecular weight of at least 5000 Da, or at least 10,000 Da, or at least 20,000 Da, or at least 25,000 Da.

The core of at least one particle may comprise a polymer in a total amount of between 0.1-10 wt % of the particle, or between 0.2-5, or between 0.5-3, or between 1-2.5 wt % of the particle.

The core of at least one particle may comprise one or more antioxidants and/or reducing agents. The core of at least one particle may comprise at least one antioxidant and/or reducing agent in a total amount of at least 0.1 wt % of the particle, or at least 0.2, 0.25, 0.5, 0.75, 1, 1.25, 1.5, 1.75, 2, 2.5, 3, or at least 3.5 wt % of the particle. The core of at least one particle may comprise at least one antioxidant and/or reducing agent in a total amount of no greater than 20 wt % of the particle, or no greater than 15, or no greater than 10 wt % of the particle.

At least one antioxidant and/or reducing agent may comprise an alkali metal and/or alkaline earth metal salt. At least one antioxidant and/or reducing agent may comprise at least one salt independently selected from the group comprising: a sulfite, thiosulfite, thiosulfate, erythorbate, citrate, ascorbate, silicate, carbonate, bicarbonate, phosphate, nitrite, and combinations thereof. At least one antioxidant and/or reducing agent may be independently selected form the group comprising: methionine, glycine, propyl gallate, tert-butyl hydroquinone, a tocopherol, thiodipropionic acid, butylated hydroxytoluene (BHT), butylated hydroxyanisol (BHA), tannic acid, and combinations thereof. At least one antioxidant and/or reducing agent may comprise at least one salt independently selected from: a thiosulfate salt, a citrate salt, a sulfate salt, and combinations thereof.

The core of at least one particle may comprise at least one polysaccharide. The core of at least one particle may comprise the polysaccharide in a total amount of at least 0.5 wt % of the particle, or at least 1, 2, 3, or at least 5 wt % of the particle. The core of at least one particle may comprise the polysaccharide in a total amount of no greater than 20 wt % of the particle, or no greater than 15, or no greater than 10 wt % of the particle.

At least one polysaccharide may be an unmodified naturally occurring polysaccharide or a modified naturally occurring polysaccharide. At least one polysaccharide may be independently selected from the group comprising: cellulose, pectin, dextrin, starch, and combinations thereof. At least one starch may be water-soluble or water-insoluble.

In some embodiments, the core of at least one particle may comprise: at least one polymer in an amount of between 0.1-10 wt % of the particle: one or more antioxidants and/or reducing agents in a total combined amount of between 0.2-10 wt % of the particle; and at least one polysaccharide in an amount of at least 2 wt % of the particle.

The core of at least one particle may comprise water, which may be present in a total amount of at least 0.025 wt % of the particle, or at least 0.05, 0.075, or at least 0.1, 0.2, 0.3, 0.4, 0.5, 0.6, 0.7, or at least 0.8 wt % of the particle. The core of at least one particle may comprise water in a total amount of no greater than 5 wt % of the particle, or no greater than 4, 3, 2, or no greater than 1.5 wt % of the particle.

The core of at least one particle may comprise at least one water-insoluble substance, preferably as described in statements of invention above. The core of at least one particle may comprise the water-insoluble substance in a total amount of between 1-15 wt % of the particle, or between 1-10, or between 1-8, or between 4-8 wt % of the particle.

The detergent composition may comprise one or more additional components independently selected from the group comprising: a builder, a co-builder, a bleaching agent, a bleach catalyst, a bleach booster, a bleach activator, an anti-foaming agent, a material care agent, a surfactant, and combinations thereof.

The detergent composition may comprise a builder and/or co-builder. The detergent composition may comprise one or more builders or co-builders independently selected from the group comprising: phosphates (such as sodium triphosphate), polycarboxylates, citrates (such as sodium citrate, which may be anhydrous), aminocarboxylates (such as methyl glycine diacetic acid (MGDA), or N,N-dicarboxylmethyl glutamic acid (GLDA)), dicarboxylic acid amines (such as iminodisuccinic acid (IDS)), alkali silicates (such as sodium silicate), carbonates (such as sodium carbonate), bicarbonates (such as sodium bicarbonate), a phosphonate, and salts and/or combinations thereof. The builder may preferably comprise a citrate, preferably trisodium citrate.

Builders reduce the effect of water hardness by removing calcium and magnesium ions and increase the effectiveness of the detergent.

The builder may be present at a concentration of at least 5 wt % of the detergent composition, or at least 10, 15, 20, 25, 30, 35, 40, 45, 50, 55, 60, 65, 70, 75, or at least 80 wt. % of the detergent composition. The builder may be present at a concentration of no more than 98 wt. % of the detergent composition, or of no more than 96, 94, 92, 90, 89, 88, 87, 86, or of no more than 85 wt. % of the detergent composition.

The detergent composition may comprise one or more further enzymes in addition to the protease. In some embodiments, the further enzyme also comprises a protease. At least one further enzyme may be independently selected from: a lipase, amylase, cellulase and peroxidase. At least one further enzyme may preferably comprise an amylase. More than one species of enzyme may be used. The total quantity of further enzymes may be from about 0.25 to about 5% wt. of the detergent composition, from about 0.5 to about 4% wt., or about 1 to about 3% wt. of the detergent composition. The detergent composition may comprise at least one amylase in a total amount as described above.

The detergent composition may comprise one or more material care agents which are effective as corrosion inhibitors and/or anti-tarnish aids. The material care agent may be selected from the group comprising: metasilicate, silicate, bismuth salts, manganese salts, paraffin, pyrazoles, thiols, mercaptans, aluminum fatty acid salts, and preferably triazoles (such as benzotriazoles), or combinations thereof. The material care agent may comprise a silver and/or copper corrosion inhibitor. Preferred silver/copper corrosion inhibitors are benzotriazole (BTA) or bis-benzotriazole and substituted derivatives thereof. Other suitable inhibitors are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

The detergent composition may comprise the material care agent in an amount of from 0.01% by weight to 5% by weight, 0.05% by weight to 3% by weight, 0.1% by weight to 2.5% by weight, 0.2% by weight to 2% by weight, 0.2% by weight to 1.5% by weight, 0.2% by weight to 1% by weight, 0.3% by weight to 0.8% by weight, or 0.4% by weight to 0.6% by weight of the composition. The detergent composition may comprise the material care agent in an amount of no greater than 5 wt %, or of no greater than 3, 2.5, 2, 1.5, 1, 0.8, 0.6, 0.4, or of no greater than 0.2 wt %. The detergent composition may comprise substantially no material care agent.

In some embodiments, the detergent composition may comprise more than one material care agent. The composition may comprise different material care agents for different purposes, such as for preventing glass corrosion, preventing silver tarnishing, preventing aluminium corrosion, etc.

The detergent composition may comprise at least one polymer, preferably at least one polycarboxylate. By the term ‘polycarboxylate’, we mean any polymeric species comprising a carboxylic acid or carboxylate groups available for chelation. The polycarboxylate polymer may be a homopolymer and/or a copolymer and/or a terpolymer.

The one or more polymer may be present in an amount of between about 3 and about 25% wt., between about 5 and about 20% wt., between about 6 and about 18% wt., between about 7 and about 16% wt., between about 8 and about 15% wt., or between about 9 and about 13% wt.

The polymer may be a polycarboxylate polymer comprising an itaconic acid copolymer.

The polymer may be a polycarboxylate polymer comprising an acrylic acid monomer.

The polymer may be a polycarboxylate polymer comprising an acrylic acid homopolymer. The homopolymer may have a molecular weight of between about 2,000 and about 10,000, between about 3,000 and about 9,000, or between about 4,000 and about 8,000. The homopolymer may be present in an amount of from about 0.1 to about 5% wt., from about 0.2 to about 4.5% wt., from about 0.3 to about 4% wt., from about 0.3 to about 3.5% wt., from about 0.4 to about 3% wt., from about 0.5 to about 2.5% wt., from about 0.6 to about 2% wt., or from about 0.7 to about 1.5% wt.

The at least one polycarboxylate may comprise a sulphonic acid monomer. The sulphonic acid monomer may be present in an amount of from about 4 to about 14% wt., from about 5 to about 13% wt., from about 6 to about 12% wt. or from about 7 to about 11% wt.

Preferred monomers containing sulphonic acid groups are those of the formula:

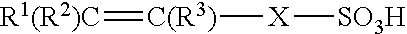

in which R¹ to R³ mutually independently denote —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH, or denote —COOH or —COOR⁴, R⁴ being a saturated or unsaturated, straight-chain or branched hydrocarbon residue with 1 to 12 carbon atoms, and X denotes an optionally present spacer group which is selected from —(CH₂)ₙ— with n=0 to 4, —COO—(CH₂)ₖ— with k=1 to 6, —C(O)—NH—C(CH₃)₂— and CH(CH₂CH₃)—.

Preferred monomers of the above formula include, for example, those of the formulae:

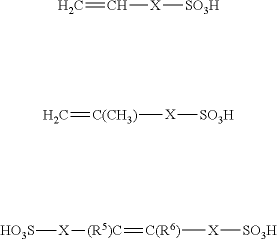

in which R⁵ and R⁶ are mutually independently selected from —H, —CH₃, —CH₂CH₃, —CH₂CH₂CH₃, —CH(CH₃)₂ and X denotes an optionally present spacer group which is selected from —(CH₂)ₙ— with n=0 to 4, —COO—(CH₂)ₖ with k=1 to 6, —C(O)—NH—C(CH₃)₂— and —C(O)—NH—CH(CH₂CH₃)—.

Preferred monomers containing sulphonic acid groups are here 1-acrylamido-1-propanesulphonic acid, 2-acrylamido-2-propanesulphonic acid, 2-acrylamido-2-methyl-1-propanesulphonic acid, 2-methacrylamido-2-methyl-1-propanesulphonic acid, 3-methacrylamido-2-hydroxypropane-sulphonic acid, allylsulphonic acid, methallylsulphonic acid, allyloxy benzenesulphonic acid, methallyloxy benzenesulphonic acid, 2-hydroxy-3-(2-propeny loxy) propanesulphonic acid, 2-methyl-2-propene-1-sulphonic acid, styrenesulphonic acid, vinylsulphonic acid, 3-sulphopropyl acrylate, 3-sulfopropyl methacrylate, sulphomethacrylamide, sulphomethylmethacry lamide and mixtures of the stated acids or the water-soluble salts thereof. Particularly preferred is 2-acrylamido-2-methyl-1-propanesulphonic acid.

The sulphonic acid groups may be present in the polymers entirely or in part in neutralized form, i.e. the acidic hydrogen atom of the sulphonic acid group may be replaced in some or all of the sulphonic acid groups with metal ions, preferably alkali metal ions and in particular with sodium ions. It is preferred according to the invention to use copolymers containing partially or completely neutralized sulphonic acid groups.

The molar mass of the sulphonic acid polymers may be varied in order to tailor the properties of the polymers to the desired intended application. The copolymers may have a molar mass of between about 2000 and about 200,000 g mol⁻¹, between about 4000 and about 25,000 g mol⁻¹, or between about 5000 and about 15,000 g mol⁻¹. The polymer preferably has a pH of from 3 to 5, such as from 3.5 to 4.5.

The polycarboxylate may be a copolymer comprising a sulphonic acid monomer and an acrylic acid monomer.

The at least one polycarboxylate comprises a maleic acid monomer. Such a polymer is preferably present in an amount of from about 0.1 to about 5 wt., from about 0.2 to about 4.5% wt., from about 0.3 to about 4% wt., from about 0.3 to about 3.5% wt., from about 0.4 to about 3% wt., from about 0.5 to about 2.5% wt., from about 0.6 to about 2%, or from about 0.7 to about 1.5% wt.

The polymer may have a viscosity of from about 500 to about 3000 mPa·s, from about 750 to about 2500 mPa·s, from about 1000 mPa·s to about 2000 mPa·s. Such a copolymer may have a molecular weight (Mw) of from about 10,000 to about 100,000 g mol⁻¹, from about 20,000 to about 80,000 g mol⁻¹, from about 30,000 to about 70,000 g mol⁻¹, or from about 45,000 to about 55,000 g mol⁻¹.

The polycarboxylate may be a copolymer comprising a maleic acid monomer and an acrylic acid monomer.

The acrylic acid-maleic acid copolymer may be formed from 2-propenoic acid and 2,5-furandione. The acrylic acid-maleic acid copolymer may have a pH of from 7 to 9, such as from 7.5 to 8.5, assessed by DIN19268.

The polymer may be an acrylic acid homopolymer, an acrylic acid-sulphonic acid, and/or an acrylic acid-maleic acid copolymer.

The polymer may comprise one or more polycarboxylate homopolymers and one or more polycarboxylate copolymers. The homopolymer(s) and copolymer(s) may be present in a ratio of from 1:20 to 1:2, preferably from 1:15 to 1:5.

The polymer may comprise polyepoxysuccinic acid (PESA) or derivatives thereof. Polyepoxysuccinic acid is also known as epoxysuccinic acid homopolymer, polyoxirane-2,3-dicarboxylic acid, 2,3-oxiranedicarboxylic acid homopolymer, or poly(1-oxacyclopropane-2,3-dicarboxylic acid); and has the general structure:
and where the derivatives thereof

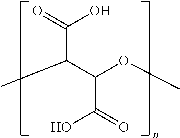

have the general structure:

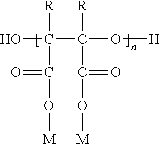

where R may be hydrogen or any organic chain (but preferably an ester such as C₁₋₄ alkyl) and where M may be any cation (preferably Na⁺, H⁺, K⁺, and/or NH₄⁺).

All references to PESA hereafter are to be taken to refer to polyepoxysuccinic acid or derivatives thereof, unless otherwise stated.

The PESA may have a molecular weight (Mw) of from about 100 to about 10,000 g mol⁻¹, from about 400 to about 2000 g mol⁻¹, from about 1000 to about 1800 g mol⁻¹. The PESA may have from about 2 to about 100 repeating monomer units, such as from about 2 to about 50, about 2 to about 45, about 2 to about 20 or from about 2 to about repeating monomer units.

The polymer may comprise PESA in an amount of from about 0.1 to about 5% wt., from 0.1 about to about 4% wt., from about 0.15 to about 3% wt., from about 0.2 to about 1.9% wt., from about 0.25 to about 1.5% wt., or from about 0.6 to about 1.1% wt. PESA is preferably present in an amount of from about 5 to about 20% wt., from about 8 to about 19% wt., or from about 9 to about 15% wt., relative to the total quantity of polymers present.

The polymer may comprise any biodegradable polymer.

The biodegradable polymer may comprise, for example, Alcoguard® H 5941.

The biodegradable polymer may comprise a bio-based carbohydrate backbone, for example starch, cellulose or inulin. The polymer may comprise one or more synthetic, fossil-based grafting group.

The polymer may be a cationic, anionic or amphoteric polymer.

The detergent composition may preferably include a bleaching system comprising at least one bleaching agent, preferably in combination with one or more of the group comprising: bleach boosters, bleach catalysts, bleach activators, and combinations thereof.

The detergent composition may comprise at least one bleaching agent.

At least one bleaching agent may be independently selected from the group comprising: an oxygen-releasing bleaching agent, a chlorine-releasing bleaching agent, and combinations thereof.

The bleaching agent may comprise the active bleach species itself or a precursor to that species. The bleaching agent may be independently selected from the group comprising: an inorganic peroxide, an organic peracid and mixtures thereof. The terms “inorganic peroxide” and “organic peracid” encompass salts and derivatives thereof. Inorganic peroxides include percarbonates, perborates, persulphates, hydrogen peroxide and derivatives and salts thereof. The sodium and potassium salts of these inorganic peroxides are suitable, especially the sodium salts. The bleaching agent may preferably comprise at least one percarbonate, which may comprise sodium percarbonate.

At least one bleaching agent be a source of an organic peroxyacid. The source of an organic peroxyacid may comprise a preformed peracid or a diacyl peroxide, or it may comprise a hydrogen peroxide source and a bleach activator. The detergent composition may comprise from about 0.1% to about 50%, or even from about 0.1% to about 25% bleaching agent by weight.

The organic peroxy acid source (peracid and/or bleach activator) may be present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracids or precursors thereof.

In some embodiments, the bleaching agent is or comprises a preformed peracid. At least one preformed peracid may be a preformed peroxyacid or salt thereof, which may comprise a peroxycarboxylic acid or salt thereof and/or a peroxysulphonic acid or salt thereof. At least one peroxycarboxylic acid or salt thereof may have a chemical structure corresponding to the following chemical formula:

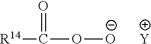

wherein: R¹⁴ is selected from alkyl, aralkyl, cycloalkyl, aryl or heterocyclic groups; the R¹⁴ group can be linear or branched, substituted or unsubstituted; and Y is any suitable counterion that achieves electric charge neutrality, preferably Y is selected from hydrogen, sodium or potassium. Preferably, R¹⁴ is a linear or branched, substituted or unsubstituted C6-C9 alkyl. Preferably, the peroxyacid or salt thereof is selected from peroxyhexanoic acid, peroxyheptanoic acid, peroxyoctanoic acid, peroxynonanoic acid, peroxydecanoic acid, any salt thereof, or any combination thereof. Preferably, the peroxyacid or salt thereof has a melting point in the range of from 30° C. to 60° C.

At least one peroxysulphonic acid or salt thereof may have a chemical structure corresponding to the following chemical formula:

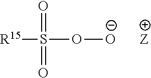

wherein: R¹⁵ is selected from alkyl, aralkyl, cycloalkyl, aryl or heterocyclic groups: the R¹⁵ group can be linear or branched, substituted or unsubstituted; and Z is any suitable counterion that achieves electric charge neutrality, preferably Z is selected from hydrogen, sodium or potassium. Preferably R¹⁵ is a linear or branched, substituted or unsubstituted C6-C9 alkyl.

In some embodiments, the bleaching agent is or comprises a hydrogen peroxide source. The hydrogen peroxide source may comprise an inorganic perhydrate salt, which may comprise an alkali metal perhydrate salt. The hydrogen peroxide source may comprise at least one inorganic perhydrate salt that is independently selected from the group comprising: a perborate salt, a percarbonate salt, a persulfate salt, a perphosphate salt, a persilicate salt, and combinations thereof. In some embodiments, the hydrogen peroxide source may comprise at least one alkali metal perhydrate salt independently selected from the group comprising: an alkali metal perborate, an alkali metal percarbonate, and combinations thereof. In a particular embodiment, the bleaching agent is or comprises an alkali metal percarbonate, preferably sodium percarbonate. The inorganic perhydrate salt may be present in a total amount of between 0.05-40 wt % of the detergent composition, or between 1-30 wt % of the detergent composition.

In some embodiments, the bleaching agent comprises a diacyl peroxide bleaching species. The diacyl peroxide (DAP) bleaching species is preferably selected from diacyl peroxides of the general formula: R¹—C(O)—OO—(O)C—R²; in which R¹ represents a C6-C18 alkyl, preferably C6-C12 alkyl group containing a linear chain of at least 5 carbon atoms and optionally containing one or more substituents (e.g. —N⁺ (CH₃)₃, —COOH or —CN) and/or one or more interrupting moieties (e.g. —CONH— or —CH—CH—) interpolated between adjacent carbon atoms of the alkyl radical, and R² represents an aliphatic group compatible with a peroxide moiety, such that R¹ and R² together contain a total of 8 to 30 carbon atoms. In one preferred embodiment, R¹ and R² are linear unsubstituted C6-C12 alkyl chains. Most preferably R¹ and R² are identical. Diacyl peroxides, in which both R¹ and R² are C6-C12 alkyl groups, are particularly preferred. Preferably, at least one of, most preferably only one of, the R groups (R¹ or R²), does not contain branching or pendant rings in the alpha position, or preferably neither in the alpha nor beta positions or most preferably in none of the alpha or beta or gamma positions. In one further preferred embodiment the DAP may be asymmetric, such that preferably the hydrolysis of R¹ acyl group is rapid to generate peracid, but the hydrolysis of R² acyl group is slow.

The tetraacyl peroxide bleaching species is preferably selected from tetraacyl peroxides of the general formula: R³—C(O)—OO—C(O)—(CH₂)ₙ—C(O)—OO—C(O)—R³; in which R³ represents a C1-C9 alkyl, preferably C3-C7 group and n represents an integer from 2 to 12, preferably 4 to 10 inclusive.

Preferably, the diacyl and/or tetraacyl peroxide bleaching species is present in an amount sufficient to provide at least 0.5 ppm, more preferably at least 10 ppm, and even more preferably at least 50 ppm by weight of the wash liquor. In a preferred embodiment, the bleaching species is present in an amount sufficient to provide from about 0.5 to about 300 ppm, more preferably from about 30 to about 150 ppm by weight of the wash liquor.

The detergent composition may comprise at least one bleaching agent in a total amount of at least 0.5 wt % of the detergent composition, or at least 1, 2, 3, 4, 5, 6, or at least 7 wt % of the detergent composition. The detergent composition may comprise at least one bleaching agent in a total amount of no greater than 50 wt % of the detergent composition, or no greater than 45, 40, 35, 30, 25, 20, 15, or no greater than 10 wt % of the detergent composition. The detergent composition may comprise at least one bleaching agent in a total amount of between 0.5-25 wt % of the detergent composition, or between 1-20, or between 1-10 wt % of the detergent composition.

The detergent composition may comprise at least one bleach activator and/or bleach catalyst.

Bleach Catalysts may be provided by one or more of the group comprising: a non-metal bleach catalyst, a catalytic metal complex, a ligand which forms a catalytic metal complex, and combinations thereof. The bleach catalyst may be used in an amount which provides 0.001-0.02 g of active material per litre of wash liquor.

The bleach catalyst may be a manganese complex comprising 1,4,7-Triazacyclononane (TACN), or any derivatives of a TACN ligand, for example 1,4,7-trimethyl-TACN, manganese oxalate, manganese acetate or a dinuclear manganese complex, for example a dinuclear manganese complex comprising TACN or any derivatives of a TACN ligand, for example 1,4,7-trimethyl-TACN.

Any suitable bleach activator may be included. The detergent composition may comprise one or more bleach activators independently selected from the group comprising: tetraacetylglycol Uril (TAGU), sodium nonaoyl oxybenzene sulphonate (SNOBS), sodium isononaoyl oxy benzene sulphonate (ISONOBS), n-nonanoylsuccinimide (NOSI), acetyl triethyl citrate (ATC), N-acyl caprolactams, short chain triglycerides (such as triacetin), and preferably tetraacetylethylenediamine (TAED), and combinations thereof.

At least one bleach activator may have the chemical formula R—(C═O)-L, wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is a leaving group. Examples of suitable leaving groups are benzoic acid and derivatives thereof—especially benzene sulphonate. Suitable bleach activators may be independently selected from: dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoy loxy benzene sulphonate (NOBS). Suitable bleach activators are also disclosed in WO 98/17767. In some embodiments, the detergent composition comprises: NOBS, TAED, or a combination thereof.

The bleach booster and/or bleach catalyst may be present in a total amount of at least 0.1 wt % of the detergent composition, or of at least 0.2, 0.3, 0.4, 0.5, 0.6, 0.7, 0.8, 0.9, 1, 1.5, 2, 2.5, 3, 3.5, or of at least 4 wt % of the detergent composition.

The bleach booster and/or bleach catalyst may be present in a total amount of no greater than 50 wt % of the detergent composition, or no greater than 45, 40, 35, 30, 25, or of no greater than 20 wt %, or of no greater than 15, or of no greater than 10 wt % of the detergent composition.

The detergent composition may comprise at least one bleaching agent and at least one species independently selected from: a bleach activator, a bleach catalyst, and combinations thereof. In some embodiments, the detergent composition comprises at least one species independently selected from: a bleaching agent, a bleach catalyst, and a bleach activator, in particulate or granular form. In such embodiments, the particles comprising the species may have a release profile such that the time required to release 50% of the actives is below 100 seconds, or below 50 seconds, or below 20 seconds.

In some embodiments, the detergent composition comprises at least one surfactant. At least one surfactant may be independently selected from the group comprising: a non-ionic surfactant, an anionic surfactant, a cationic surfactant, a zwitterionic surfactant, a semi-polar surfactant, and combinations thereof. At least one surfactant may preferably be non-ionic surfactant.

The detergent composition may comprise at least one anionic surfactant which may be independently selected from the group comprising: a linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid, soap, and combinations thereof.

Non-limiting examples of anionic surfactants include sulfates and sulfonates, in particular, linear alkylbenzenesulfonates (LAS), branched alkylbenzenesulfonates (BABS), phenylalkanesulfonates, alpha-olefinsulfonates (AOS), olefin sulfonates, al25 kene sulfonates, alkane-2, 3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfosuccinic acid or soap, and combinations thereof.

The detergent composition may comprise at least one cationic surfactant which may be independently selected from the group comprising: alklydimethylehanolamine quat (ADMEAQ), cetyltrimethylammonium bromide (CTAB), dimethyldisteary lammonium chloride (DSDMAC), and alkylbenzyldimethylammonium, and combinations thereof.

The detergent composition may comprise at least one non-ionic surfactant which may be independently selected from the group comprising: an alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, N-acyl N-alkyl derivatives of glucosamine (“glucamides”), a fatty alcohol alkoxylate, a modified fatty alcohol polyglycol ether, an ethylene oxide-propylene oxide copolymer (linear or branched), and combinations thereof.

The detergent composition may comprise at least one non-ionic surfactant independently selected from the group comprising: an alcohol ethoxylate (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamide (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

The detergent composition may contain from about 0.2% to about 40% by weight of a non-ionic surfactant, for example from about 0.5% to about 30%, in particular from about 1% to about 20%, from about 1% to about 10%, such as from about 1% to about 5%.

The detergent composition may comprise at least one semipolar surfactant, which may be independently selected from the group comprising: amine oxides (AO) such as alkyldimethylamineoxide, N-(coco alkyl)-N, N-dimethylamine oxide and N-(tallow-alkyl)-N, N-bis(2-hydroxyethyl)amine oxide, fatty acid alkanolamides and ethoxylated fatty acid alkanolamides, and combinations thereof.

The detergent composition may comprise at least one zwitterionic surfactant which may be independently selected from the group comprising: betaine, alkyldimethylbetaine, sulfobetaine, and combinations thereof.

The detergent composition may comprise the surfactant in a total amount of at least 0.25 wt % of the detergent composition, or at least 0.5, 0.75, 1, 1.25, or at least 1.5 wt % of the detergent composition. The detergent composition may comprise the surfactant in a total amount of no greater than 15 wt % of the detergent composition, or no greater than 10, 9, 8, 7, 6, or no greater than 5 wt % of the detergent composition.

In some embodiments, the detergent composition is in the form of a powder, liquid, gel, tablet, pouch, or block. The detergent composition may preferably be a solid. The detergent composition may preferably be a powdered or granulated solid.

The detergent composition may be an automatic dishwashing detergent composition.

According to a third aspect of the invention, there is provided a detergent composition comprising at least one protease enzyme coated with a delayed release coating composition comprising at least one sorbitan fatty acid ester.

Preferably the protease is as described for the first or second aspect of the invention.

At least one sorbitan fatty acid ester may preferably be as described in statements of invention for the first and second aspects of the invention above.

According to a fourth aspect of the invention, there is provided a detergent composition comprising at least one protease enzyme coated with a delayed release coating composition comprising palm oil in a total amount of greater than 31 wt. % of the delayed release coating composition.

Preferably the protease is as described for the first or second aspect of the invention.

The following statements apply to the third and fourth aspects of the invention.

The detergent composition of the third and/or fourth aspects of the invention may be detergent compositions of the first and/or second aspects of the invention. Statements of invention above relating to the detergent compositions of the first and second aspects of the invention or to any component thereof may also be applied to the third and fourth aspects of the invention.

Any statements of invention for the first or second aspects of the invention above may be applied mutatis mutandis to the third and fourth aspects of the invention.

In some embodiments, at least one protease enzyme is of animal, vegetable or microbial origin. At least one protease may be a serine protease and/or a metalloprotease. At least one protease may be an alkaline microbial protease and/or a trypsin-like protease. In some embodiments, at least one protease is a subtilisin, which may be derived from Bacillus. At least one protease may be a subtilisin that is independently selected from the group comprising: subtilisin Novo, subtilisin Carlsberg, subtilisin 309, subtilisin 147, subtilisin 168, and combinations thereof.

In some embodiments, at least one protease enzyme comprises at least one enzyme having at least 70%, 75%, 80%, 85%, 90%, 95%, 96%, 96.5%, or at least 97% identity with SEQ ID NO:1. In some embodiments, at least one protease has at least 99% identity or has 100% identity with SEQ ID NO: 2.

According to a fifth aspect of the invention, there is provided a package or device comprising a detergent composition of the first, second, third or fourth aspect of the invention.

Any statements of invention above for any of the first, second, third and fourth aspects of the invention may also be applied to the fifth aspect of the invention.

In some embodiments, the package or device comprises a water-soluble container.

Where reference is made below to any components of the detergent composition referenced previously in the first, second, third or fourth aspects of the invention, statements of invention relating to the components for the first, second, third and fourth aspects of the invention may equally apply.

The package or device may comprise a water-soluble container.

By the term ‘water-soluble container’ as used herein, it is meant a container which at least partially dissolves in water or disperses in water at 20° C. within 10 minutes to allow for egress of the contents of the package into the surrounding water.

In some embodiments, the package or device comprises a unit-dose format.

By ‘unit-dose’, it is meant that the product comprises one or more compositions in the quantity required for a single wash cycle of a machine dishwasher.

The water-soluble container may comprise or be a water-soluble film. The water-soluble film may be rigid or flexible at room temperature.

The water-soluble container may comprise or may be made of a poly(vinyl alcohol) (PVOH) film. The PVOH film may be partially or fully alcoholised or hydrolysed, for example, it may be from 40 to 100%, preferably 70 to 92%, most preferably about 85% to about 92%, alcoholised or hydrolysed, polyvinyl acetate film. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water. The film may be cast, blown or extruded. It may further be unoriented, mono-axially oriented or bi-axially oriented.

The PVOH film may be a thermoformed PVOH film.

The package or device may be a multi-compartment container, preferably a water-soluble container. The detergent composition may be located in at least one compartment of the multi-compartment container. The multi-compartment container may comprise two or more, three or more, four or more, five or more, or six or more separated compartments. Each of the compartments may be arranged side-by-side, concentrically, as sectors of a circle or in any suitable random or organised pattern. The container may comprise a first PVOH film comprising a pocket and a surrounding flange, and a second PVOH film, applied as a cover across the pocket and sealed across the flange. The container may comprise a first PVOH film comprising more than one pocket, for example two or more, three or more, four or more, five or more, or six or more pockets, and a surrounding flange, and a second PVOH film, applied as a cover across each pocket and sealed across the flange. In some embodiments there are three or four pockets.

Beneficially, a multi-compartment container allows compositions of different forms (i.e. solid form, liquid form or gel form) to be located within different compartments. Such a container is aesthetically more appealing to consumers.

The multi-compartment container may comprise solid, liquid and gel components. The solid, liquid and gel components may be located in different compartments of the container. The solid component may be or comprise the detergent composition.

The multi-compartment container may comprise the detergent composition of the invention and one or more additional components selected from the group comprising: builders, co-builders, bleaching agents, anti-foaming agents, material care agents, surfactants, and combinations thereof. The one or more additional components may be as described in the first aspect of the invention. The detergent composition and the one or more additional components may be located in different compartments of the multi-compartment container. Alternatively, the detergent composition and the one or more additional components may be located in the same compartment.

The multi-compartment container may comprise at least a first compartment and a second compartment. The multi-compartment container may comprise at least a first compartment, a second compartment and a third compartment. In addition to the detergent composition of the invention, the multi-compartment container may comprise at least one further composition in the form of a solid, liquid, gel or paste. The at least one further composition in the form of a solid, liquid, gel or paste may comprise one or more cleaning actives selected from the list containing a builder, surfactant, alkalinity source, acidity source, enzyme, polymer, anti-corrosion agent, bleaching agent or care agent, or a mixture thereof.

The multi-compartment container may comprise at least a first compartment and a second compartment, and the detergent composition of the invention may be located within the first compartment. The multi-compartment container may further comprise one or more of a solid, a gel, a gel comprising a suspension of a powder or granules, and a liquid, in addition to the detergent composition of the invention. Each further composition may be located in its own separate compartment, or two or more further compositions may be co-located in at least one further compartment, for example.

The container may comprise at least one liquid cleaning active located within a second compartment. The at least one liquid cleaning active may be a bleaching system. The bleaching system may comprise a bleaching agent, for example a percarbonate, for example sodium percarbonate, a bleach booster, for example tetraacety lethy lenediamine (TAED), and/or a bleach catalyst, for example a manganese complex comprising triazacyclononane (TACN), or any derivatives of a TACN ligand, for example 1,4,7-trimethyl-TACN, or manganese oxalate, manganese acetate or a dinuclear manganese complex, for example a dinuclear manganese complex comprising TACN or any derivatives of a TACN ligand, for example 1,4,7-trimethyl-TACN. The bleaching agent may comprise any bleaching agent described in the first aspect of the invention. Statements of invention relating to bleaching agents of the first aspect of the invention may be applied here.

The container may comprise at least one solid cleaning active located within a second compartment. The at least one solid cleaning active may be a bleaching system. The solid bleaching system may be in the form of a powdered solid. The solid, or powdered solid, bleaching system may be in the form of a coated granule or co-granule with one or more cleaning actives. The bleaching system may comprise a bleaching agent as described above. The bleaching agent may comprise any bleaching agent of the first aspect of the invention.

The detergent composition may comprise one or more cleaning actives selected from the list comprising: a builder, surfactant, alkalinity source, acidity source, enzyme, polymer, anti-corrosion agent, bleaching agent, material care agent, and mixtures thereof. Statements of invention relating to one or more of the above stated cleaning actives in the first aspect of the invention may be applied here. The one or more cleaning actives may be in granular form. The one or more cleaning actives may be at least one enzyme selected from the group comprising protease, amylase, lipase, cellulase and peroxidase, or mixtures thereof.

In some embodiments, the detergent composition is present in an amount of at least 5 wt % of the package or device, or at least 10, 15, 20, 25, or at least 30 wt % of the package or device. In some embodiments, the detergent composition is present in an amount of no greater than 100 wt %, or no greater than 95, 90, 85, 80, 75, or no greater than 70 wt % of the package or device. The detergent composition may be present in an amount of between 5-80, 5-70, 10-60, 15-50, 20-45, or between 30-40 wt %, or between 20-40 wt % of the package or device.

In general, the maximum dimension of the filled part of the package or device (excluding any flanges) may be 10 cm or 8 cm. For example, a rounded cuboid container may have a length of 1 to 5 cm, especially 3.5 to 4.8 cm, for example 4.8 cm or 4.1 cm, a width of 1.5 to 4 cm, especially 3 to 4 cm, for example 3.7 cm or 3.9 cm, and a height of 1 to 2.5 cm, especially 1 to 2 cm, for example 1.25 to 1.75 cm.

According to a sixth aspect of the invention, there is provided a method of manufacturing a detergent composition of the first aspect of the invention, the method comprising the steps of:
(a) Providing at least one protease enzyme having at least 95% identity with SEQ ID NO: 1; and
(b) Coating the or each protease enzyme with a delayed release coating composition comprising at least one hydrophobic species.

According to a seventh aspect of the invention, there is provided a method of manufacturing a detergent composition of the second aspect of the invention, the method comprising the steps of:
(a) Providing at least one protease enzyme having at least 99% identity with SEQ ID NO: 2, preferably having 100% identity with SEQ ID NO:2; and
(b) Coating the or each protease enzyme with a delayed release coating composition comprising at least one hydrophobic species

According to an eighth aspect of the invention, there is provided a method of manufacturing a detergent composition of the third aspect of the invention, the method comprising the steps of:
(a) Providing at least one protease enzyme; and
(b) Coating the or each protease enzyme with a delayed release coating composition comprising at least one sorbitan fatty acid ester.

According to a ninth aspect of the invention, there is provided a method of manufacturing a detergent composition of the fourth aspect of the invention, the method comprising the steps of:
(a) Providing at least one protease enzyme; and
(b) Coating the or each protease enzyme with a delayed release coating composition comprising palm oil in a total amount of greater than 31 wt. % of the delayed release coating composition.

The following statements apply to the sixth, seventh, eighth and ninth aspects of the invention.

Statements of invention above relating to any previous aspect of the invention may be applied mutatis mutandis to the sixth, seventh, eighth and ninth aspects of the invention.

Step (a) of the method may comprise providing a core comprising the protease enzyme, and step (b) may comprise coating the core with the delayed release coating composition to form a particle.

The core may be prepared by granulation. The core may be prepared by a granulation method independently selected from the group comprising: crystallisation, precipitation, pan-coating, fluid bed coating, fluid bed agglomeration, rotary atomization, extrusion, prilling, spheronization, size reduction methods, drum granulation, high shear granulation, and combinations thereof.

The delayed release coating composition may be present as a single coating layer surrounding the core. Alternatively, the delayed release coating composition may be present as more than one layer surrounding the core. In some embodiments, the delayed release coating composition comprises 2 or at least 2 layers, or 3 or at least 3 layers surrounding the core.

In some embodiments, the method may further comprise coating the core with at least one undercoat layer before coating the core with the delayed release coating composition. At least one undercoat layer may comprise a salt layer as described for the first aspect of the invention above. In some embodiments, the method may comprise: coating the core with at least one topcoat layer after coating the core with the delayed release coating composition. At least one topcoat layer may comprise a salt layer as described for the first aspect of the invention above.

According to a tenth aspect of the invention, there is provided a detergent composition of the first, second, third or fourth aspect of the invention for washing soiled kitchenware.

Statements of invention above relating to any previous aspect of the invention may be applied mutatis mutandis to the tenth aspect of the invention.

The kitchenware may comprise tableware, such as, for example, crockery, cutlery and the like.

According to an eleventh aspect of the invention, there is provided a method of washing kitchenware in an automatic dishwashing machine, wherein a detergent composition of the first, second, third or fourth aspect of the invention or a package or device of the fifth aspect of the invention is added to the automatic dishwashing machine at the start of a main wash cycle or at the start of a pre-wash cycle.

Statements of invention above relating to any previous aspect of the invention may be applied mutatis mutandis to the eleventh aspect of the invention.

The detergent composition or the package or device may be added to the automatic dishwashing machine at any suitable stage of the washing cycle, such as at the start of a main wash cycle or at the start of a pre-wash cycle. The detergent composition or the package or device may be added to a dosing basket or a dosing chamber within the automatic dishwashing machine. The detergent composition or the package or device may be placed on a floor of the automatic dishwashing machine.

Sequence Listings

SEQ ID NO: 1-Bacillus lentus subtilisin 309
AQSVPWGISRVQAPAAHNRGLTGSGVKVAVLDTGISTHPDLNIRGGAS
FVPGEPSTQDGNGHGTHVAGTIAALNNSIGVLGVAPSAELYAVKVLGA
SGSGSVSSIAQGLEWAGNNGMHVANLSLGSPSPSATLEQAVNSATSRG
VLVVAASGNSGAGSISYPARYANAMAVGATDQNNNRASFSQYGAGLD
IVAPGVNVQSTYPGSTYASLNGTSMATPHVAGAAALVKQKNPSWSNV
QIRNHLKNTATSLGSTNLYGSGLVNAEAATR
SEQ ID NO: 2
AQSVPWGIRRVQAPTAHNRGLTGSGVKVAVLDTGISTHPDLNIRGGAS
FVPGEPSTQDENGHGTHAAGTIAALNNSIGVLGVAPSAELYAVKVLGA
SGSGSVSSIAQGLEWAGNNGMHVANLSLGSPSPSATLEQAVNSATSRG
VLVVAASGNSGAGSISYPARYANAMAVGATDQNNNRASFSQYGPGLD
IVAPGVNIQSTYPGSTYASLNGTSMATPHVAGAAALVKQKNPSWSNVR
IRNHLKNTATSLGSTDLYGSGLVNAEAATR

### DETAILED DESCRIPTION OF THE INVENTION

In order that the invention may be more clearly understood embodiments thereof will now be described, by way of example only.

### Preparation of Detergent Compositions of the Invention

Solid detergent compositions were prepared and added to a multi-compartment container along with a gel and liquid composition. The solid detergent composition, gel and liquid compositions were each placed in separate compartments of the multi-compartment container.

The following compositions were prepared.

### Comparative Detergent Composition (not of the Invention)

The comparative detergent composition had a composition as displayed in Table 1 below.

TABLE 1

| | Comparative solid | Gel + liquid |
|---|---|---|
| | detergent composition (not | compositions |
| | of the invention) [g/wash] | [g/wash] |
| Builder | 8.06 | 2.17 |
| Bleaching agent | 0.75 | |
| Bleach activator and catalyst | 0.40 | |
| Amylase | 0.16 | |
| Surfactant | 0.20 | 1.83 |
| Fragrance | 0.05 | |
| Colorant | | 0.003 |
| Standard granular protease | 0.29 | |
| enzyme (not coated with a | | |
| delayed release coating of the | | |
| invention) | | |
| Total | 9.90 | 4.00 |

### Inventive Detergent Compositions

The prepared inventive detergent compositions were solid compositions containing particles comprising a core which contained a protease enzyme of SEQ ID NO:2, and further contained a delayed release coating composition comprising a hydrophobic species surrounding the core.

Two inventive detergent compositions were prepared (Inventive Composition 1 and Inventive Composition 2). The inventive detergent compositions had a general composition as displayed in Table 2 below, but the delayed release coating differed for both compositions. Identical gel and liquid compositions were used with all detergent compositions, and these were added to a multi-compartment container along with the inventive solid detergent compositions, as described above.

TABLE 2

| | Inventive solid | Gel + liquid |
|---|---|---|
| | detergent | compositions |
| | compositions [g/wash] | [g/wash] |
| Builder | 8.06 | 2.17 |
| Bleaching agent | 0.75 | |
| Bleach activator and catalyst | 0.40 | |
| Amylase | 0.16 | |
| Surfactant | 0.20 | 1.83 |
| Fragrance | 0.05 | |
| Colorant | | 0.003 |
| Protease enzyme of SEQ ID NO: 2 | 0.29 | |
| coated with delayed release | | |
| coating composition 1 or 2 | | |
| Total | 9.90 | 4.00 |

### Inventive Composition 1 Delayed Release Coating

The delayed release coating composition used to coat the protease enzyme in Inventive Composition 1 contained dehydrogenated palm oil which was present in an amount of between 31-40 wt % of the delayed release coating composition. The delayed release coating composition also contained kaolin and titanium dioxide water-insoluble substances which were present in a total combined amount of between 60-69 wt % of the delayed release coating composition.

### Inventive Composition 2 Delayed Release Coating

The delayed release coating composition used to coat the protease enzyme in Inventive Composition 2 contained sorbitan monostearate which was present in an amount of between 31-40 wt % of the delayed release coating composition. The delayed release coating composition also contained kaolin and titanium dioxide water-insoluble substances which were present in a total combined amount of between 60-69 wt % of the delayed release coating composition.

### In-Wash Testing of Prepared Detergent Compositions

A first round of tests was conducted under the following EU conditions:

| | |
|---|---|
| Dishwasher | Bosch |
| Program | Eco50 + Vario Speed |
| Water consumption | Ca. 11 L total |
| Water hardness | 21°GH |
| Machine loading | Ballast dishes, no soil, no salt, no rinse aid |

Procedure: Multi-compartment containers containing the above prepared solid detergent compositions and gel and liquid compositions were placed in the dishwasher dosing chamber. After the dosing chamber opened, the first sample from the wash liquor was taken (t=0). Subsequent samples of wash liquor (approx. 10 mL) were extracted via a bypass in intervals of one minute, mixed with 100 mg Na₂SO₃ to quench remaining active oxygen species and analysed for their protease activity.

Results: The results showed that whilst the Comparative composition reached a max plateau concentration of protease enzyme in the wash liquor just 4 minutes after dosage, the Inventive compositions displayed a delayed release of the protease enzymes, reaching max plateau concentrations after ca. 16 minutes after dosing (Inventive Composition 1) and 10 minutes after dosing (Inventive Composition 2).

A second round of tests was conducted using the Comparative Composition and Inventive Composition 1 under the following US conditions:

| | |
|---|---|
| Dishwasher | Whirlpool WDF540 |

| | | |
|---|---|---|
| Program | 1 | hour |

| | |
|---|---|
| Water consumption | Ca. 22 L total |

| | | |
|---|---|---|
| Water temperature | 49° | C. |
| Water hardness | 200 | ppm |

| | |
|---|---|
| Machine loading | Ballast dishes, no soil, no salt, no rinse aid |

Procedure: The procedure was the same as described for tests under EU conditions above.

Results: Results once again showed rapid release of protease enzyme from the Comparative Composition, which reached a max plateau protease concentration in the wash liquor just 3 minutes after dosage. Inventive Composition 1 once again displayed delayed release of the protease enzymes, reaching a max plateau concentration ca. 8-9 minutes post-dosing.

A further round of tests was conducted under EU conditions to compare the protease release profile of the prepared detergent compositions with the release profile of active oxygen from a bleaching agent during a dishwashing operation.

Results: The Comparative detergent composition displayed rapid protease release and reached a max plateau protease concentration in the wash liquor just 3 minutes after dosage, which was faster than the time taken for the active oxygen concentration from the bleaching agent to reach a max plateau (ca. 5 minutes). Inventive compositions once again displayed a delayed release of the protease enzymes, reaching max plateau concentrations after ca. 16 minutes after dosing (Inventive Composition 1) and 10 minutes after dosing (Inventive Composition 2).

In all of the above tests, the Inventive compositions displayed good delayed release properties and excellent dishwashing performance. Inventive compositions displayed significantly improved performance against bleachable tea stains vs the Comparative composition, demonstrating that enzyme performance for the Inventive compositions was not negatively impacted by bleaching agents and other harsh chemicals in the formulation.

The above embodiments are described by way of example only. Many variations are possible without departing from the scope of the invention as defined in the appended claims.

1. A detergent composition comprising at least one protease enzyme having at least 95% identity with SEQ ID NO:1, wherein the or each protease enzyme is coated with a delayed release coating composition comprising at least one hydrophobic species.

2. The detergent composition as claimed in claim 1, wherein the at least one protease enzyme comprises at least 97% identity with SEQ ID NO:1.

3. The detergent composition as claimed in claim 1, wherein the at least one protease enzyme comprises a variant of the amino acid sequence of SEQ ID NO: 1 comprising a substitution at one or more positions selected from 9, 15, 59, 66, 188, 199, 239 and 255.

4. The detergent composition as claimed in claim 3, wherein the protease variant comprises substitutions at positions 9, 15, 59, 66, 188, 199, 239 and 255.

5. The detergent composition as claimed in claim 4, wherein the protease variant comprises the substitutions S9R, A15T, G59E, V66A, A188P, V199I, Q239R, and N255D.

6. The detergent composition comprising at least one protease enzyme having at least 99% identity with SEQ ID NO: 2, wherein the or each protease enzyme is coated with a delayed release coating composition comprising at least one hydrophobic species.

7. The detergent composition as claimed in claim 6, wherein the at least one protease enzyme consists of the amino acid sequence of SEQ ID NO:2.

8. The detergent composition as claimed in claim 1, wherein the at least one hydrophobic species comprises at least one fatty acid or ester thereof.

9. The detergent composition as claimed in claim 1, wherein the at least one hydrophobic species comprises at least one fatty acid or ester thereof, and wherein the at least one fatty acid or ester thereof is present in a total amount of between 20-70 wt. % of the delayed release coating composition.

10. The detergent composition as claimed in claim 1, wherein the at least one hydrophobic species comprises at least one fatty acid or ester thereof having a fatty acid chain length of between 4-40 carbon atoms.

11. The detergent composition as claimed in claim 1, wherein the at least one hydrophobic species comprises at least one glycerol fatty acid ester and/or sorbitan fatty acid ester.

12. The detergent composition as claimed in claim 1, wherein the at least one hydrophobic species comprises a species that is independently selected from the group comprising: a palm oil derivative, a sorbitan fatty acid ester, and combinations thereof.

13. The detergent composition as claimed in claim 1, wherein the at least one hydrophobic species comprises at least one hydrocarbon having between 5-60 carbon atoms.

14. The detergent composition as claimed in claim 1, wherein the at least one hydrophobic species is present in a total amount of between 20-70 wt. % of the delayed release coating composition.

15-18. (canceled)

19. A package or device comprising a detergent composition according to claim 1.

20-24. (canceled)

25. A method of washing kitchenware in an automatic dishwashing machine, wherein a detergent composition of claim 1 is added to the automatic dishwashing machine at the start of a main wash cycle or at the start of a pre-wash cycle.

26. The detergent composition of claim 6, wherein at least one of:
the at least one hydrophobic species comprises at least one fatty acid or ester thereof;
the at least one hydrophobic species comprises at least one fatty acid or ester thereof, and the at least one fatty acid or ester thereof is present in a total amount of between 20-70 wt. % of the delayed release coating composition;
the at least one hydrophobic species comprises at least one fatty acid or ester thereof having a fatty acid chain length of between 4-40 carbon atoms;
the at least one hydrophobic species comprises at least one glycerol fatty acid ester and/or sorbitan fatty acid ester;
the at least one hydrophobic species comprises a species that is independently selected from the group comprising: a palm oil derivative, a sorbitan fatty acid ester, and combinations thereof;
the at least one hydrophobic species comprises at least one hydrocarbon having between 5-60 carbon atoms; and/or
the at least one hydrophobic species is present in a total amount of between 20-70 wt. % of the delayed release coating composition.

27. A method of washing kitchenware in an automatic dishwashing machine, wherein a package or device of claim 19 is added to the automatic dishwashing machine at the start of a main wash cycle or at the start of a pre-wash cycle.

28. A package or device comprising a detergent composition according to claim 6.

29. A method of washing kitchenware in an automatic dishwashing machine, wherein a package or device of claim 28 is added to the automatic dishwashing machine at the start of a main wash cycle or at the start of a pre-wash cycle.
